(19) United States
(12) Patent Application Publication
(10) Pub. No.: US 2010/0007933 A1
(43) Pub. Date: Jan. 14, 2010

(54) MOVABLE BODY APPARATUS, AND OPTICAL INSTRUMENT USING THE MOVABLE BODY APPARATUS

(75) Inventors: Kazunari Fujii, Kawasaki-shi (JP); Takahiro Akiyama, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/498,682

(22) Filed: Jul. 7, 2009

(30) Foreign Application Priority Data
Jul. 8, 2008 (JP) 2008-177451

(51) Int. Cl. G02B 26/10; H02K 33/00

(52) U.S. Cl. 359/199.3; 310/38

(57) ABSTRACT

An apparatus includes an oscillatory system having first and second movable bodies, and first and second elastic support portions, a driving portion having a permanent magnet, and a drive controlling portion. The oscillatory system has at least two characteristic oscillation modes of first and second resonance frequencies. The drive controlling portion supplies a driving signal to the driving portion so that the movable body of the oscillatory system is swingingly rotated. The swinging rotation is performed such that a sum of time periods wherein the angular displacement of the movable body changes in one direction is different from a sum changes in its opposite direction. The drive controlling portion includes a waveform adjusting portion for adjusting the driving signal.

### BACKGROUND OF THE INVENTION

1. Field of the Invention

The present invention relates to the technology of a movable body apparatus including an oscillatory system with plural movable bodies. Particularly, the present invention relates to a movable body apparatus suitable for an optical deflector.

2. Related Background Art

Heretofore, various optical deflectors wherein mirrors are resonantly driven have been proposed. In general, a resonance type optical deflector is characterized in that, comparing to a light scanning optical system using a rotary polygonal mirror, the optical deflector can be made compact to a large extent, and the consumption power thereof can be reduced. Particularly, an optical deflector comprising Si single-crystal manufactured by a semiconductor process theoretically has no metal fatigue, and is excellent in durability.

In the meantime, in the resonance type deflector, since an angular displacement of its mirror changes in sine-wise in principle, an angular velocity of a light beam deflected by the mirror is not constant. To correct this property, several techniques have been proposed.

In U.S. Pat. Nos. 4,859,846 and 5,047,630, there is proposed a driving method of changing the angular displacement of the mirror approximately in a chopping or triangular wave by using a resonance type deflector having oscillation modes of a fundamental frequency and a third harmonic of the fundamental frequency.

FIG. 8 illustrates a micro mirror for achieving the chopping-wave drive. An optical deflector 12 includes movable bodies 14 and 16, elastic support portions 18 and 20, driving portions 23 and 50, detecting portions 15 and 32, and a control circuit 30. The micro mirror has the fundamental resonance frequency and the approximate third harmonic of the fundamental frequency, and is driven with a driving signal at a synthesized frequency of the fundamental frequency and its third harmonic. The movable body 14 with a mirror is thus driven in a chopping-wave manner so that a fluctuation in the angular velocity of the angular displacement of scanning light is made smaller than that of the sine-wave drive.

The detecting portions 15 and 32 detect the oscillating motion of the movable body 14, and the control circuit 30 generates a driving signal for achieving the chopping-wave drive. The driving signal is supplied to the driving portions 23 and 50. Thus, the driving portions 23 and 50 drive the micro mirror. A region of an approximate equi-angular velocity of the thus-driven mirror is larger than that of the mirror driven in the sine-wise manner, and a usable region in the entire scanning range can be widened. Here, the mirror is driven with the fundamental frequency and its third harmonic, or the third harmonic of the fundamental frequency and its one-third frequency.

The above-described movable body apparatus (or optical deflector) can be driven in the chopping-wave or saw-tooth manner. However, when an electromagnetic driving portion of the movable body apparatus is comprised of a permanent magnet and a coil, there is a possibility that a desired angular displacement trajectory of the movable body is difficult to obtain if a magnetization direction (polarity) of the permanent magnet fixed to the movable body differs from an appropriate one with respect to a direction of the magnetic field generated by the coil. For example, consider a case where magnetic materials 220 are placed on respective movable bodies 200 in oscillatory systems 230 in a wafer 210 as illustrated in FIGS. 5A and 5B, all the magnetic materials 220 on the wafer 210 are magnetized at a time, and the wafer 210 is chipped into plural pieces of the oscillatory systems 230. In such a case, the magnetization direction of the oscillatory systems 230 in one group is different from that in another group. That is, with respect to the direction of the magnetic field generated by the driving coil, different kinds of oscillatory systems 230 with different magnetization directions are fabricated.

Particularly, in a case where an approximate saw-tooth drive is to be achieved by a movable body with an oscillatory system having a fundamental frequency and its second harmonic resonance frequency, two kinds of angular displacement trajectories, as illustrated in FIGS. 7A and 7B, of the movable body occur depending on the difference in the magnetization direction when driven by a driving signal having a single waveform. In the trajectory of FIG. 7A, a time period wherein the angular displacement • changes in one direction from a plus side to a minus side is longer than a time period wherein the angular displacement • changes in its opposite direction from the minus side to the plus side. In the trajectory of FIG. 7B, vice versa. Thus, there is a possibility that a desired angular displacement trajectory of the movable body cannot be obtained.

### SUMMARY OF THE INVENTION

According to one aspect, the present invention provides a movable body apparatus including an oscillatory system, a driving portion for driving the oscillatory system, a drive controlling portion for supplying a driving signal to the driving portion. The oscillatory system includes a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis. The driving portion includes a permanent magnet fixed to at least one of the movable bodies, and a coil capable of applying a driving force to the permanent magnet. The oscillatory system has at least two characteristic oscillation modes of first resonance frequency f1 and second resonance frequency f2 about the torsional axis. The drive controlling portion supplies the driving signal to the driving portion so that the movable body in the oscillatory system is swingingly rotated about the torsional axis. The swinging rotation is performed in such a manner that a sum of time periods wherein the angular displacement of the movable body changes in one direction is different from a sum of time periods wherein the angular displacement of the movable body changes in its opposite direction. The drive controlling portion includes a waveform adjusting portion for adjusting the driving signal so that a time region of a motion of the swinging rotation in one direction can be interchanged with a time region of a motion of the swinging rotation in its opposite direction.

According to another aspect, the present invention provides an optical instrument including the movable body apparatus. A light deflecting member is disposed on at least one of the movable bodies so that a light beam from a light source is deflected by the light deflecting member to guide at least a portion of the light beam to a light irradiation object.

According to another aspect, the present invention provides a method of producing a movable body apparatus including the following steps. In a first step, an oscillatory system is fabricated. The oscillatory system includes a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis. In a second step, a magnetic material is disposed on at least one of the movable bodies. In a third step, the magnetic material is magnetized. In a fourth step, a magnetization direction of the magnetic material is stored in a memory for a drive controlling portion for drive-controlling the oscillatory system.

According to another aspect, the present invention provides a method of producing a movable body apparatus including the following steps. In a first step, an oscillatory system is fabricated. The oscillatory system includes a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis. In a second step, a magnetic material is disposed on at least one of the movable bodies. In a third step, the magnetic material is magnetized. In a fourth step, an indication for indicating a magnetization direction of the magnetic material is recorded on a portion of the oscillatory system.

According to another aspect, the present invention provides a method of driving an oscillatory system includes the following steps. In a first step, a movable body of an oscillatory system is swingingly rotated about a torsional axis by a driving signal in such a manner that a sum of time periods wherein an angular displacement of the movable body changes in one direction is different from a sum of time periods wherein the angular displacement of the movable body changes in its opposite direction. In a second step, a condition of the swinging rotation executed by the driving signal is detected. In a third step, based on a result of the detection, the driving signal is maintained unchanged, or the driving signal is adjusted so that a time region of a motion of the swinging rotation in one direction is interchanged with a time region of a motion of the swinging rotation in its opposite direction.

According to another aspect, the present invention provides a method of driving an oscillatory system includes the following steps. In a first step, a magnetization direction of a magnetic material disposed on at least one of movable bodies is stored in a memory. In a second step, the movable body of the oscillatory system is swingingly rotated about a torsional axis by a driving signal adjusted based on the magnetization direction of the magnetic material stored in the first step in such a manner that a sum of time periods wherein the angular displacement of the movable body changes in one direction is different from a sum of time periods wherein the angular displacement of the movable body changes in its opposite direction.

According to the present invention, the driving signal can be adjusted so that the time region of the motion of the swinging rotation in one direction is interchanged with the time region of the motion of the swinging rotation in its opposite direction. Hence, a desired swinging rotation of the movable body can be achieved according to a situation of its use. Particularly, irrespective of the magnetization direction of the permanent magnet in the oscillatory system, a desired swinging rotation of the movable body and a desired light scanning can be achieved. For example, when a light beam is deflected and scanned by the light deflecting member on the movable body, either of a region where the light beam is scanned in one direction and a region where the light beam is scanned in its opposite direction can be a desired region with a wider area where the angular velocity is approximately constant, irrespective of the magnetization direction of the permanent magnet.

Further features of the present invention will become apparent from the following description of exemplary embodiments, with reference to the attached drawings.

### BRIEF DESCRIPTION OF THE DRAWINGS

FIG. 1 is a view illustrating an embodiment of a movable body apparatus according to the present invention.

FIG. 2A is a graph showing the relationship between time and angular displacement of the oscillating motion of a movable body in the movable body apparatus of the embodiment, and FIG. 2B is a graph showing the relationship between time and angular velocity of the oscillating motion of the movable body.

FIGS. 3A and 3B are graphs showing two changing manners of the angular displacement of the movable body interchangeable with each other by a waveform adjusting portion.

FIG. 4 is a flowchart of an embodiment of a method of producing a movable body apparatus.

FIG. 5A is a plan view showing positions of oscillatory systems in a wafer in a step of fabricating the oscillatory systems, and FIG. 5B is a plan view showing positions of magnetic materials in the wafer in a step of installing magnetic materials.

FIG. 6 is a perspective view illustrating an embodiment of an image forming apparatus with an optical deflector using the movable body apparatus according to the present invention.

FIGS. 7A and 7B are graphs showing two changing manners of the angular displacement of the movable body interchangeable with each other by a waveform adjusting portion.

FIG. 8 is a block diagram illustrating a prior art optical deflector.

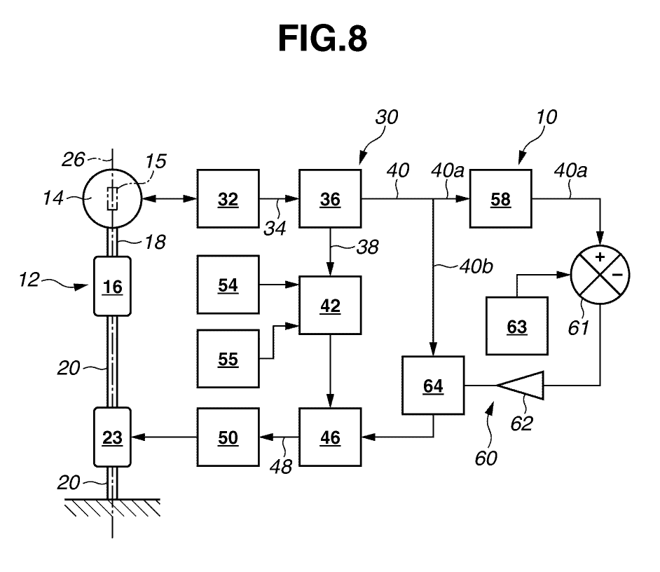

### DETAILED DESCRIPTION OF THE EMBODIMENTS

Embodiments of the present invention will hereinafter be described. A fundamental embodiment of a movable body apparatus according to the present invention includes the above-described elements. That is, the movable body apparatus includes the oscillatory or vibratory system, the driving portion for driving the oscillatory system, the drive controlling portion for supplying the driving signal to the driving portion. The swinging rotation is performed in an asymmetrical manner, as described above. The drive controlling portion can adjust the driving signal so that the time region of the motion in one direction can be interchanged with the time region of the motion in its opposite direction.

The swinging rotation can be any asymmetrical motion. Typical one is a swinging rotation of an approximate saw-tooth type wherein a longer time region of the motion involves the approximate equi-angular velocity region. Such a saw-tooth swinging rotation can be achieved by, for example, a synthesized driving signal of frequency components whose drive frequency relationship is 1:2. Although the swinging rotation is typically performed in a resonance mode, it can also be performed in a non-resonance mode. When the relationship between f1 and f2 is approximately 1:2, a resonance swinging rotation can be achieved by, for example, a driving signal represented by the following formula (1). Here, the driving signal D(t) includes at least a component of formula (1).

D(t)=•*B₁ sin •₁t+•*B₂ sin(•₂t+•) (1)

where B₁ is the amplitude of a first signal component, B₂ is the amplitude of a second signal component, • is the relative phase difference between the signal components, t is the time, •₂=2*•₁, •₁≈2*•*f1, and •₂≈2*•*f2.

In this case, the waveform adjusting portion can interchange the time region of the motion of the swinging rotation in one direction with that in its opposite direction by interchanging •=+1 with •=−1 while maintaining •=+1, or interchanging •=•=+1 with •=•=−1. Such adjustment of the driving signal can be executed by the waveform adjusting portion based on the magnetization direction of the permanent magnet. For example, information of the magnetization direction is indicated by the indication recorded on a portion of the oscillatory system. This indication is read, and the thus-read magnetization direction is stored in a memory for the drive controlling portion. Thus, when the asymmetrical swinging rotation of the movable body is to be performed, a desired swinging rotation of the movable body and a desired light scanning can be achieved, irrespective of the magnetization direction of the permanent magnet in the oscillatory system.

As can be seen from the foregoing, the oscillatory system can be driven by the following driving method. First, the magnetization direction of the magnetic material is stored in the memory. Then, with the driving signal adjusted based on the thus-stored magnetization direction, the movable body is swingingly rotated about the torsional axis in the asymmetrical manner. When the detecting portion is provided so that the condition of the swinging rotation caused by the driving signal can be detected, the oscillatory system can be driven by the above-described another driving method. In this case, the condition of the asymmetrical swinging rotation caused by the driving signal is detected. And, based on the result of the detection, the driving signal is maintained unchanged, or the driving signal is adjusted so that the time region of the motion of the swinging rotation in one direction is interchanged with that in its opposite direction.

The movable body apparatus can be used in the optical instrument like an image forming apparatus. In this case, the light deflecting member like a mirror is disposed on at least one of the movable bodies so that the light beam from the light source is deflected by the light deflecting member to guide at least a portion of the light beam to the light irradiation object such as a photosensitive member or a screen. For example, in the image forming apparatus, a light source controlling portion is provided so that a driving signal for driving the light source is generated according to an image signal supplied from outside. Here, for example, the light source controlling portion controls the driving signal for the light source based on the interchange of the time regions executed by the waveform adjusting portion. Thus, an image can be formed on the photosensitive member in a predetermined fashion.

The movable body apparatus can be produced by the above-described producing method. One producing method includes the first step of fabricating the oscillatory system, the second step of disposing the magnetic material on at least one of the movable bodies, the third step of magnetizing the magnetic material, and the fourth step of storing the magnetization direction of the magnetic material in the memory for the drive controlling portion. In another producing method, the fourth step is replaced by the step of recording the indication for indicating the magnetization direction of the magnetic material on a portion of the oscillatory system. In this case, the step of reading the indication, and the step of storing the thus-read information of the magnetization direction in the memory can be added.

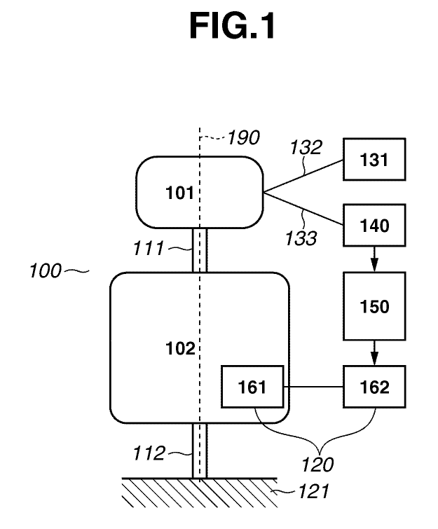

A first embodiment of the movable body apparatus and optical deflector of the present invention will be described with reference to the drawings. In this embodiment, an oscillatory system 100 includes a first movable body 101 and a second movable body 102, as illustrated in FIG. 1. The oscillatory system 100 further includes a first elastic support portion 111 for connecting the first movable body 101 to the second movable body 102 in a swingingly rotatable manner about a torsional axis 190, and a second elastic support portion 112 for connecting the second movable body 102 to a stationary portion 121 in a swingingly rotatable manner about the torsional axis 190.

The movable body apparatus can be used, for example, as the optical deflector by providing the light deflecting member like a reflective mirror on a surface of the first movable body 101. The reflective member can be provided by forming a metal layer of aluminum or the like by a sputtering method.

A driving portion 120 for driving the oscillatory system 100 can drive the oscillatory system 100 by a magnetic force of a permanent magnet 161 placed on the second movable body 102 and an electromagnetic force generated by a coil 162 fixed near the permanent magnet 161. The oscillatory system 100 has at least two characteristic oscillation modes of first resonance frequency f1 and second resonance frequency f2 about the torsional axis 190. The relationship between f1 and f1 is approximately 1:2. Here, “approximately” means that the relationship between f1 and f2 is 1.98•f2/f1•2.02. Thereby, an approximate saw-tooth drive of the first movable body 101 can be achieved.

When an appropriate driving signal is applied to the coil 162 of the driving portion 120, the angular displacement • of the oscillating motion of the first movable body 101 in the movable body apparatus can be represented by the following formula (2) where A₁, •₁ and •₁ are amplitude, angular frequency and phase of the first oscillating motion, A₂, •₂(•₂=2*•₁) and •₂ are amplitude, angular frequency and phase of the second oscillating motion, and t is the time with a certain time being an origin or standard time.

•(t)=A₁sin(•₁t+•₁)+A₂ sin(•₂t+•₂) (2)

Alternatively, the angular displacement • of the first movable body 101 can be represented by the following formula (3) where A₁ and •₁ are amplitude and angular frequency of the first oscillating motion, A₂ and •₂(•₂=2*•₁) are amplitude and angular frequency of the second oscillating motion, • is the relative phase difference between the two frequency components, and t is the time.

•(t)=A₁ sin •₁t+A₂ sin(•₂t+•) (3)

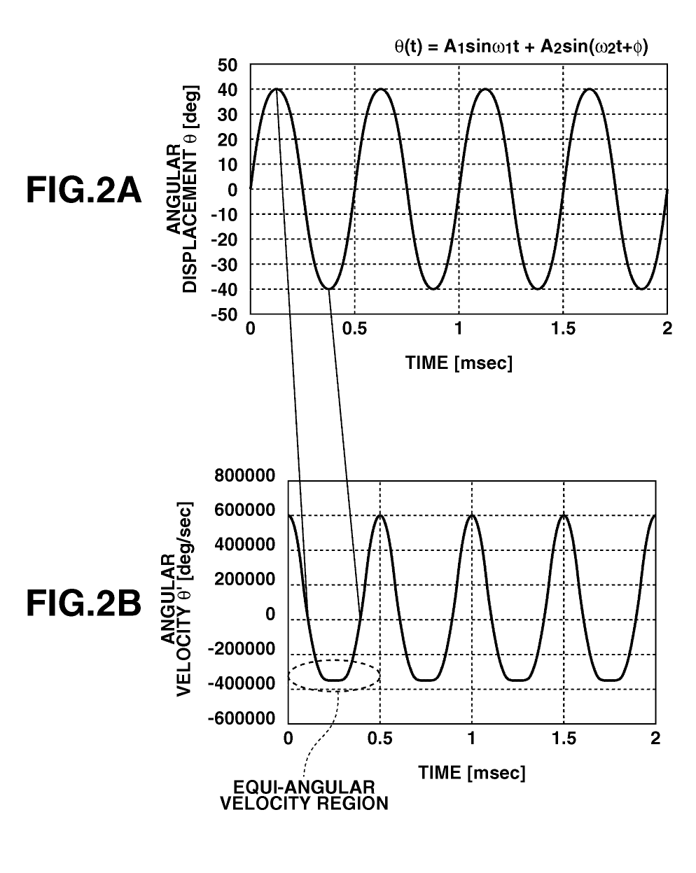

FIG. 2A shows the above oscillating motion of the oscillatory system 100. The first movable body 101 in the oscillatory system can perform a synthesized oscillating motion of the oscillating motion represented by • (t)=A₁ sin •₁ t and the oscillating motion represented by • (t)=A₂ sin(•₂t+•). Further, FIG. 2B shows a result obtained by differentiating the above formula (2) representing the above oscillating motion of the oscillatory system 100. As illustrated in FIG. 2B, the oscillating motion of the oscillatory system 100 involves the time period wherein the angular displacement • changes from the plus side to the minus side and there is the region of the approximate equi-angular velocity.

In the construction illustrated in FIG. 1, an angular displacement detecting portion 140 monitors a light beam 133 deflected by the oscillating motion of the first movable body 101. A light source 131 emits a light beam 132. A drive controlling portion 150 generates a driving signal based on a detection signal from the detecting portion 140 so that the oscillatory system 100 performs such a oscillating motion as represented by formula (2) or formula (3). The driving signal is supplied to the driving portion 120.

The driving signal can be any signal so long as it causes a resonant oscillation of the first movable body 101 represented by formula (2) or formula (3). For example, it can a driving signal synthesized by plural sine waves, or a pulsed driving signal. In the case of the synthesized driving signal of sine waves, it can be a driving signal represented by, for example, a formula including at least the term of B₁ sin(•₁t)+B₂ sin(•₂t+•) where B₁ and B₂ are the amplitude components, • is the relative phase difference, •₁ and •₂ are the angular frequencies, t is the time, and •₂=2*•₁. In this case, a desired driving signal can be obtained by adjusting amplitude and phase of each sine-wave component. In the case of the pulsed signal, a desired driving signal can be generated by changing the number, interval, width and the like of pulses with time. For example, the pulsed signal can be generated from the above synthesized signal of plural sine waves by determining a change with time of the number, interval, width and the like of pulses according to a predetermined rule.

The drive controlling portion 150 includes the waveform adjusting portion. The waveform adjusting portion interchanges the first oscillating motion with the second oscillating motion by adjusting the driving signal. In the first oscillating motion, the region of the approximate equi-angular velocity of the oscillatory system 100 exists in the region wherein • changes from the plus side to the minus side. In the second oscillating motion, the region of the approximate equi-angular velocity of the oscillatory system 100 exists in the region wherein • changes from the minus side to the plus side. For such purpose, the waveform adjusting portion interchanges •=+1 with •=−1 while maintaining •=+1 in the driving signal D(t) represented by formula (1), for example.

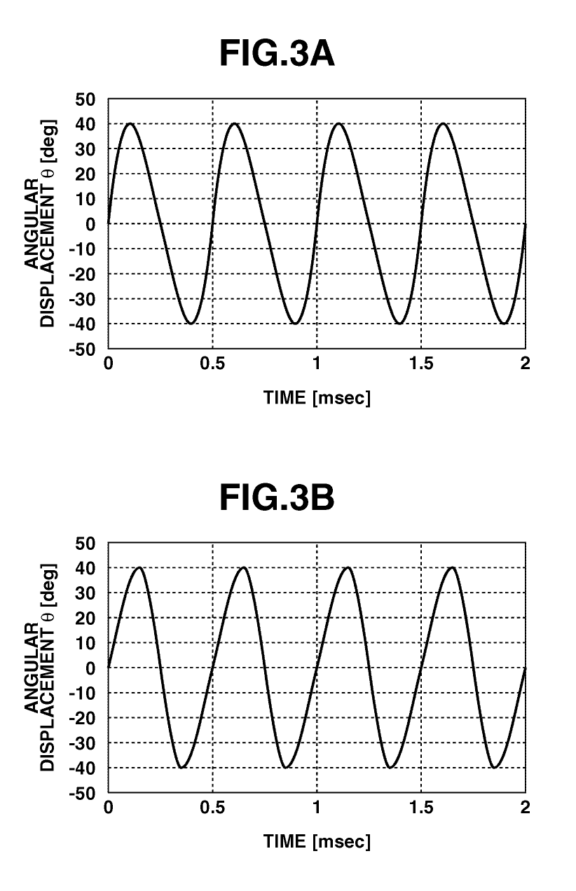

FIGS. 3A and 3B show the angular displacements • of the movable body apparatus in cases of •=+1(•=+1) and •=−1(•=+1), respectively. In the trajectory of FIG. 3A, the time period wherein the angular displacement • changes in one direction from the plus side to the minus side is longer than the time period wherein the angular displacement • changes in its opposite direction from the minus side to the plus side. The region of the approximate equi-angular velocity of the oscillatory system 100 exists in the former region. In the trajectory of FIG. 3B, vice versa.

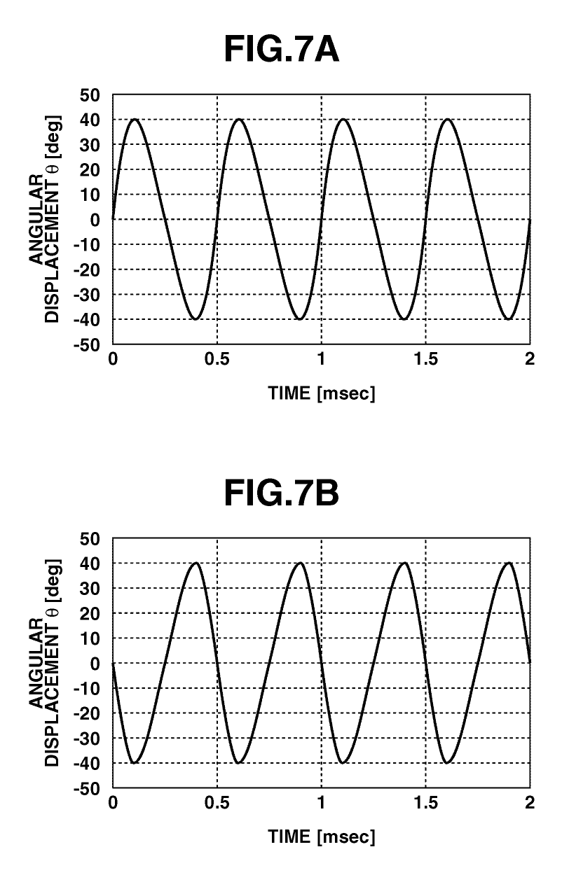

In this embodiment, it is also possible to interchange •=•=+1 with •=•=−1. FIGS. 7A and 7B show the angular displacements • of the movable body apparatus in cases of •=•=+1 and •=•=−1, respectively. In the trajectory of FIG. 7A, the time period wherein the angular displacement • changes in one direction from the plus side to the minus side is longer than the time period wherein the angular displacement • changes in its opposite direction from the minus side to the plus side. The region of the approximate equi-angular velocity of the oscillatory system 100 exists in the former region. In the trajectory of FIG. 7B, vice versa.

Thereby, the oscillating motion is interchangeable between the motion wherein the period of the approximate equi-angular velocity of the oscillatory system 100 exists in the region wherein • changes from the plus side to the minus side, and the motion wherein the period of the approximate equi-angular velocity of the oscillatory system 100 exists in the region wherein • changes its opposite direction. The waveform adjusting portion can change the generated driving signal as described above. Alternatively, the waveform adjusting portion can change a polarity of the coil 162 (a current direction of the coil) by a switch or the like while keeping the driving signal unchanged.

In this embodiment, the adjustment can be performed so that the time period of the approximate equi-angular velocity exists in the time region wherein the angular displacement about the torsional axis changes from the plus side to the minus side, or the time region wherein the angular displacement about the torsional axis changes in its opposite direction. The adjustment can be determined according to a situation. For example, it can be determined according to the polarity of the permanent magnet and a desired swinging rotation of the movable body.

As described above, the detecting portion can detect the light beam deflected by the movable body in the oscillatory system, or detect the angular displacement of the movable body itself. The detecting portion measures time at which the scanning light beam passes a predetermined scan position, or time at which the movable body takes a predetermined angular displacement. In a case where the light deflecting member, such as the reflective mirror, is provided on a surface of the movable body to reflect and deflect the light beam from the light source, a light receiving device of the detecting portion can be disposed so that the scanning light beam passes it twice within a single scanning period. In this case, the oscillating condition of the movable body can be detected based on times at which the scanning light beam passes the light receiving device, and the driving signal can be generated based on the detection result. The driving signal is supplied to the driving portion.

The detecting portion can be composed of any detector, such as a piezoelectric element, that can detect the oscillating condition of the movable body. For example, a piezoelectric sensor can be disposed in the elastic support portion. An electrostatic capacitive sensor, a magnetic sensor or the like can also be used.

A second embodiment of the present invention will be described. The second embodiment of the movable body apparatus including the oscillatory system 100 is basically the same as the first embodiment.

In this embodiment, the drive controlling portion 150 includes a waveform adjusting portion. This waveform adjusting portion changes the driving signal according to the magnetization direction of the permanent magnet 161 fixed to the second movable body 102, so that the time period of the approximate equi-angular velocity of the oscillatory system 100 is caused to exist in a desired region of the two regions described above. The waveform adjusting portion has a construction capable of interchanging •=+1 with •=−1 while maintaining •=+1 in the driving signal D(t) represented by formula (1).

A portion for recognizing the magnetization direction of the permanent magnet 161 can perform any one of the following methods. These methods are a method of measuring by a gauss meter, a method of beforehand reading a record (indication) indicating the magnetization direction of the magnet in the oscillatory system, and a method of detecting the magnetization direction based on the phase of a change in the angular displacement relative to the driving signal (a change in the trajectory of the scanning light beam in the case of the optical deflector). The phase of a change in the angular displacement relative to the driving signal has a delay according to the oscillation manner when the movable body is resonantly driven. Accordingly, by detecting such delay of the angular displacement, the magnetization direction of the permanent magnet 161 can be recognized. In the case of the non-resonance driving, no delay of the phase appears. However, the magnetization direction of the permanent magnet 161 can be recognized by detecting a change in the angular displacement of the movable body with the detecting portion like the piezoelectric element.

Also in the second embodiment, even when the magnetization direction of the permanent magnet differs between the movable body apparatuses, the time period of the approximate equi-angular velocity of the oscillatory system 100 can be caused to exist in a desired region of the two regions described above.

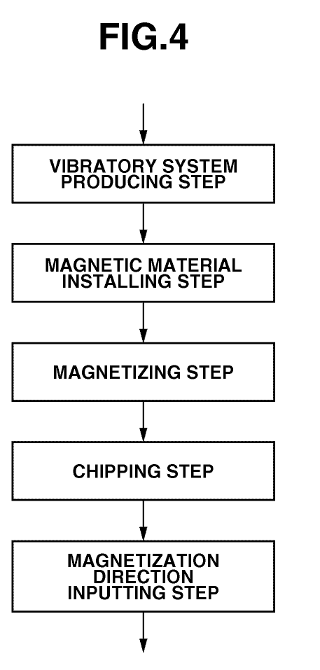

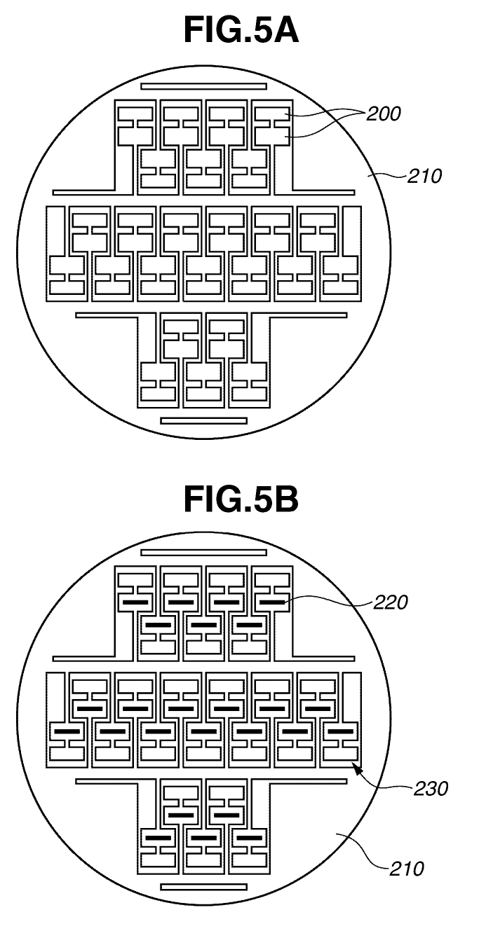

A third embodiment will be described. FIG. 4 shows the flowchart of a method of producing the movable body apparatus. In an oscillatory or vibratory system producing step, the oscillatory system is fabricated as illustrated in FIG. 5A by etching the silicon wafer 210 or the like. As illustrated in FIG. 5A, the number of devices obtained per wafer can be increased by arranging the oscillatory systems 230 in a mutually inverted manner.

In a magnetic material installing step, linear magnetic materials 220 are fixed to the devices or movable bodies 200 in the wafer 210, as illustrated in FIG. 5B. Adhesive is deposited on the movable body 200, and the magnetic material 220 is placed thereon. The adhesive is hardened by UV (ultra-violet) radiation to fix the magnetic material 220 to the movable body 200.

In a magnetizing step, the magnetic material 220 is magnetized by a magnetizing apparatus. All the magnetic materials 220 on the wafer 210 can be magnetized at a time by placing the wafer 210 in the magnetizing apparatus. Thus, the throughput of the magnetizing step can be improved. In a chipping step, the wafer 210 is chipped into pieces of the oscillatory systems 230. The chipping can be performed by cutting a coupling portion of the oscillatory system 230 with laser light.

In a magnetization direction inputting step, the magnetization direction of the magnetic material 220 is input into a memory in the drive controlling portion 150. The magnetization direction of the magnetic material 220 can be discriminated based on the position of the magnetic material 220 on the wafer 210. In the producing method of this embodiment, it is also possible to store the position of the oscillatory system 230 on the wafer 210 even after the chipping, and discriminate the position of the magnetic material 220 based on such information. Further, it is also possible to apply a mark to the oscillatory system 230 according to its position in the oscillatory system producing step, and discriminate the magnetization direction of the magnetic material 220 by reading the mark. Other than those methods, there is a method of measuring the magnetization direction by a gauss meter or the like, or a method of oscillating the oscillatory system to detect the magnetization direction based on the phase of the scanning trajectory relative to the driving signal.

In the producing method of this embodiment, the magnetization direction is stored in the memory for the drive controlling portion 150. Therefore, even when the magnetization direction of the permanent magnet differs between the movable body apparatuses, the time period of the approximate equi-angular velocity of the oscillatory system can be caused to exist in a desired region of the two time regions described above. That is, the adjustment can be performed so that the time period of the approximate equi-angular velocity exists in a desired region of time regions wherein the angular displacement about the torsional axis changes in one direction and wherein the angular displacement changes in its opposite direction.

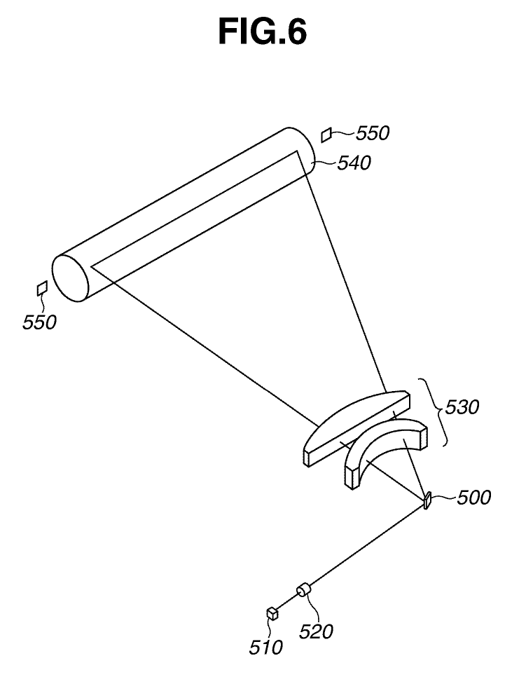

A fourth embodiment will be described with reference to FIG. 6. This embodiment is directed to an image forming apparatus including the optical deflector using the movable body apparatus of the present invention. An optical deflector 500 in this embodiment is the movable body apparatus described in the first embodiment. A light beam from a light source 510 is shaped by an optical system of a collimator lens 520, and the light beam is deflected and scanned one-dimensionally by the optical deflector 500. The scanning light beam is condensed by an optical system of a coupling lens 530 on a target position of a photosensitive member 540 which is the light irradiation object. Thus, an electrostatic latent image is formed on the photosensitive member 540.

Further, two optical detectors 550 are arranged at scanning ends of the optical deflector 500. In the optical deflector 500, an appropriate driving waveform is generated based on information of the magnetization direction of the permanent magnet, using the method described in the second embodiment. Thus, a desired image can be formed on the photosensitive member 540.

A fifth embodiment will be described with reference to FIG. 6. This embodiment is also directed to an image forming apparatus including the optical deflector using the movable body apparatus of the present invention. The optical deflector 500 in this embodiment is also the movable body apparatus described in the first embodiment.

In this embodiment, a light source controlling portion (not shown) for controlling the light source 510 acts as follows. Adjustment is performed so that the time period of the approximate equi-angular velocity exists in either of the two time regions described above, based on information of the magnetization direction of the permanent magnet obtained by the method of the second embodiment. At the same time, the light source controlling portion controls a driving signal for driving the light source 510 according to the adjustment result. Thereby, a desired image can be formed on the photosensitive member 540.

Except as otherwise discussed herein, the various components shown in outline or in block form in the Figures are individually well known and their internal construction and operation are not critical either to the making or using, or to a description of the best mode of the invention.

This application claims the benefit of Japanese Patent Application No. 2008-177451, filed Jul. 8, 2008, which is hereby incorporated by reference herein in its entirety.

What is claimed is:

1. A movable body apparatus comprising:
an oscillatory system including a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
a driving portion for driving the oscillatory system, the driving portion including a permanent magnet fixed to at least one of the movable bodies, and a coil capable of applying a driving force to the permanent magnet; and
a drive controlling portion for supplying a driving signal to the driving portion,
wherein the oscillatory system has at least two characteristic oscillation modes of first resonance frequency f1 and second resonance frequency f2 about the torsional axis, the drive controlling portion supplies the driving signal to the driving portion so that the movable body of the oscillatory system is swingingly rotated about the torsional axis, the swinging rotation is performed in such a manner that a sum of time periods wherein an angular displacement of the movable body changes in one direction is different from a sum of time periods wherein the angular displacement of the movable body changes in a direction opposite to the one direction, and the drive controlling portion includes a waveform adjusting portion for adjusting the driving signal so that a time region of a motion of the swinging rotation in one direction can be interchanged with a time region of a motion of the swinging rotation in a direction opposite to the one direction.

2. The movable body apparatus according to claim 1, wherein a relationship between f1 and f2 is approximately 1:2.

3. The movable body apparatus according to claim 1, wherein the waveform adjusting portion adjusts the driving signal based on a magnetization direction of the permanent magnet.

4. The movable body apparatus according to claim 3, wherein information of the magnetization direction of the permanent magnet is recorded in a portion of the oscillatory system.

5. The movable body apparatus according to claim 1, wherein the driving signal includes at least a component of a formula represented by
D(t)=•*B₁ sin •₁t+•*B₂ sin(•₂t+•),
where B₁ is an amplitude of a first signal component, B₂ is an amplitude of a second signal component, • is a relative phase difference between the signal components, t is time, •₂=2*•₁, •₁≈2*•*f1, and •₂≈2*•*f2, and
wherein the waveform adjusting portion has a construction capable of interchanging •=+1 with •=−1 while maintaining •=+1 in the driving signal, or interchanging •=•=+1 with •=•=−1.

6. An optical instrument comprising:
a movable body apparatus according to claim 1; and
a light deflecting member disposed on at least one of the movable bodies so that a light beam from a light source is deflected by the light deflecting member to guide at least a portion of the light beam to a light irradiation object.

7. A method of producing a movable body apparatus, the method comprising the steps of:
fabricating an oscillatory system which includes a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
placing a magnetic material on at least one of the movable bodies;
magnetizing the magnetic material; and
storing a magnetization direction of the magnetic material in a memory for a drive controlling portion for drive-controlling the oscillatory system.

8. A method of producing a movable body apparatus, the method comprising the steps of:
fabricating an oscillatory system which includes a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
placing a magnetic material on at least one of the movable bodies;
magnetizing the magnetic material; and
recording an indication for indicating a magnetization direction of the magnetic material on a portion of the oscillatory system.

9. A method of driving an oscillatory system, the method comprising the steps of:
causing a swinging rotation of a movable body in an oscillatory system about a torsional axis by a driving signal in such a manner that a sum of time periods wherein an angular displacement of the movable body changes in one direction is different from a sum of time periods wherein the angular displacement of the movable body changes in a direction opposite to the one direction, the oscillatory system including a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
detecting a condition of the swinging rotation executed by the driving signal;
keeping the driving signal unchanged, or adjusting the driving signal so that a time region of a motion of the swinging rotation in one direction is interchanged with a time region of a motion of the swinging rotation in a direction opposite to the one direction, based on a result of the detection.

10. A method of driving an oscillatory system, the method comprising the steps of:
storing a magnetization direction of a magnetic material disposed on at least one of movable bodies of an oscillatory system in a memory, the oscillatory system including a first movable body, a second movable body, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
adjusting a driving signal based on the stored magnetization direction of the magnetic material; and
causing a swinging rotation of the movable body in the oscillatory system about the torsional axis by the adjusted driving signal in such a manner that a sum of time periods wherein an angular displacement of the movable body changes in one direction is different from a sum of time periods wherein the angular displacement of the movable body changes in a direction opposite to the one direction.

11. An apparatus comprising:
an oscillatory system including first and second movable bodies, a first elastic support portion for connecting the first movable body to the second movable body in a swingingly rotatable manner about a torsional axis, and a second elastic support portion for connecting the second movable body to a stationary portion in a swingingly rotatable manner about the torsional axis;
a driving portion for driving the oscillatory system, the driving portion including a permanent magnet fixed to at least one of the movable bodies, and a coil capable of applying a driving force to the permanent magnet; and
a drive controlling portion for supplying a driving signal to the driving portion,
wherein the oscillatory system has at least two characteristic oscillation modes of first resonance frequency f1 and second resonance frequency f2 about the torsional axis.

12. The apparatus according to claim 11, wherein a relationship between f1 and f2 is approximately 1:2.

13. The apparatus according to claim 11, wherein the drive controlling portion supplies the driving signal to the driving portion so that the movable body of the oscillatory system is swingingly rotated about the torsional axis, the swinging rotation is performed in such a manner that a sum of time periods wherein an angular displacement of the movable body changes in one direction is different from a sum of time periods wherein the angular displacement of the movable body changes in a direction opposite to the one direction.

14. The apparatus according to claim 13, wherein the drive controlling portion includes a waveform adjusting portion for adjusting the driving signal so that a time region of a motion of the swinging rotation in one direction can be interchanged with a time region of a motion of the swinging rotation in a direction opposite to the one direction.

15. A method comprising:
causing a swinging rotation of a movable body in an oscillatory system about a torsional axis by a driving signal in such a manner that a sum of time periods wherein an angular displacement of the movable body changes in one direction is different from a sum of time periods wherein the angular displacement of the movable body changes in an opposite direction;
detecting a condition of the swinging rotation executed by the driving signal; and
adjusting the driving signal so that a time region of a motion of the swinging rotation in one direction is interchanged with a time region of a motion of the swinging rotation in a direction opposite to the one direction, based on a result of the detection.

16. The method according to claim 15, wherein the oscillatory system including first and second movable bodies, a first elastic support portion for connecting the first movable body to the second movable body in a swingingly rotatable manner about a torsional axis, and a second elastic support portion for connecting the second movable body to a stationary portion in a swingingly rotatable manner about the torsional axis.

17. A method comprising:
storing a magnetization direction of a magnetic material disposed on at least one of movable bodies of an oscillatory system in a memory;
adjusting a driving signal based on the stored magnetization direction of the magnetic material; and
causing a swinging rotation of the movable body in the oscillatory system about the torsional axis by the adjusted driving signal such a sum of time periods wherein an angular displacement of the movable body changes in one direction is different from a sum of time periods wherein the angular displacement of the movable body changes in a direction opposite to the one direction.

18. The method according to claim 17, wherein the oscillatory system including first second movable bodies, a first elastic support portion for connecting the first movable body to the second movable body in a swingingly rotatable manner about a torsional axis, and a second elastic support portion for connecting the second movable body to a stationary portion in a swingingly rotatable manner about the torsional axis.
